(19) United States
(12) Patent Application Publication
(10) Pub. No.: US 2020/0064177 A1
(43) Pub. Date: Feb. 27, 2020

(54) SYSTEMS AND METHODS FOR STORED LIQUID MONITORING

(71) Applicant: Roth River, Inc., Louisville, KY (US)

(72) Inventors: David Durand, Prospect, KY (US); Todd Pritts, Prospect, KY (US); Larry Horn, Louisville, KY (US); Jeffrey Thomas Cesnik, Winchester, VA (US)

(21) Appl. No.: 16/543,844

(22) Filed: Aug. 19, 2019

Related U.S. Application Data
(60) Provisional application No. 62/720,531, filed on Aug. 21, 2018.
(60) Provisional application No. 62/783,440, filed on Dec. 21, 2018.

(51) Int. Cl. G01F 23/38; H04W 4/80; G01F 17/00

(52) U.S. Cl. CPC G01F 23/38; G01F 17/00; H04W 4/80

(57) ABSTRACT

Systems and methods for remotely monitoring liquids that are stored in containers are provided. Various aspects of the liquid can be monitored, such as volume level, pressure level, and temperature. Liquid monitoring systems can be installed into each container, with each liquid monitoring system collecting information and wirelessly providing it to a centralized monitoring system.

### CROSS-REFERENCE TO RELATED APPLICATIONS

This application claims the benefit of U.S. application No. 62/720,531, filed Aug. 21, 2018, and entitled SYSTEMS AND METHODS FOR MONITORING LIQUIDS UNDERGOING THE AGING PROCESS, the disclosure of which is incorporated herein by reference in its entirety and also claims the benefit of U.S. application No. 62/783,440 filed Dec. 21, 2018, and entitled SYSTEMS AND METHODS FOR STORED LIQUID MONITORING, the disclosure of which is incorporated herein by reference in its entirety.

### BACKGROUND

Various types of liquids may be stored in containers, whether during production, processing, transportation, distribution, sale, or consumption. For example, during the production of wine, beer, or other types of alcohol and/or spirits, the liquid may be stored in a barrel for an extended period of time, which may range from several months to a number of years. During storage in the barrel, the liquid may undergo a process of fermentation, or aging, in preparation for eventual sale, distribution, and/or consumption.

The barrel, or other type of container, may be made of wood, of which oak is a common element for a variety of alcohol types, or other materials. Certain types of containers may not be completely air tight (whether by design, or by limitation) and a certain amount of liquid may escape, evaporate, leak, or otherwise decrease by volume over time. For example, a wood barrel may absorb a certain amount of the liquid over time, may be constructed of a porous wood that allows for the liquid to evaporate over time, or may include small cracks or openings that allow the liquid to leak out of the container.

### BRIEF DESCRIPTION OF THE DRAWINGS

It is believed that certain embodiments will be better understood from the following description taken in conjunction with the accompanying drawings, in which like references indicate similar elements and in which:

FIG. 1 schematically depicts a storage container in accordance with one non-limiting embodiment

FIG. 2 schematically depicts a non-limiting example of a liquid monitoring system.

FIG. 3 schematically depicts a non-limiting example of a liquid monitoring system.

FIG. 4 schematically depicts a non-limiting example of a liquid monitoring system.

FIG. 5 depicts an example embodiment of a liquid monitoring system can that can be installed into a wooden storage container.

FIG. 6 depicts an example embodiment of a liquid monitoring system can that can be installed into a wooden storage container.

FIG. 7 depicts an example embodiment of a liquid monitoring system can that can be installed into a wooden storage container.

FIG. 8 depicts an example embodiment of a liquid monitoring system can that can be installed into a wooden storage container.

FIG. 9A depicts an exploded view of an example liquid monitoring system prior to installation into a wall of a container.

FIG. 9B depicts the liquid monitoring system subsequent to installation into the wall of the container.

FIGS. 10-11 schematically depict pivot assemblies of example liquid monitoring systems in accordance with one non-limiting embodiment.

FIGS. 12A-12B schematically depict the tracking of liquid volume in a container in accordance with various non-limiting embodiments.

FIGS. 13-14 show example components of a liquid monitoring system in accordance with one non-limiting embodiment.

FIG. 15 shows a block diagram of an example liquid monitoring system in accordance with one non-limiting embodiment.

FIG. 16 shows a block diagram of an example liquid monitoring system in accordance with one non-limiting embodiment.

FIG. 17 depicts a plurality of example storage containers stored on a rack.

FIG. 18 depicts an operational environment in accordance with one non-limiting embodiment.

FIG. 19 schematically depicts a simplified example user interface that can be generated by a barrel monitoring computing system.

FIGS. 20-21 depict example interfaces that may be presented on a mobile communications device.

FIGS. 22-27 depict a liquid monitoring system in accordance with another example embodiment.

FIGS. 28-29 show an example liquid monitoring system in accordance with one non-limiting embodiment.

### DETAILED DESCRIPTION

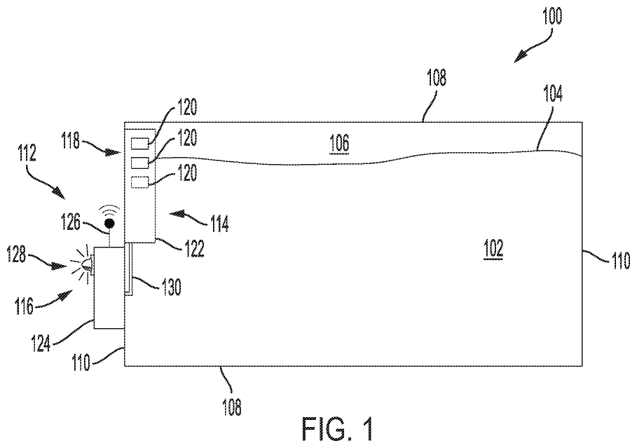

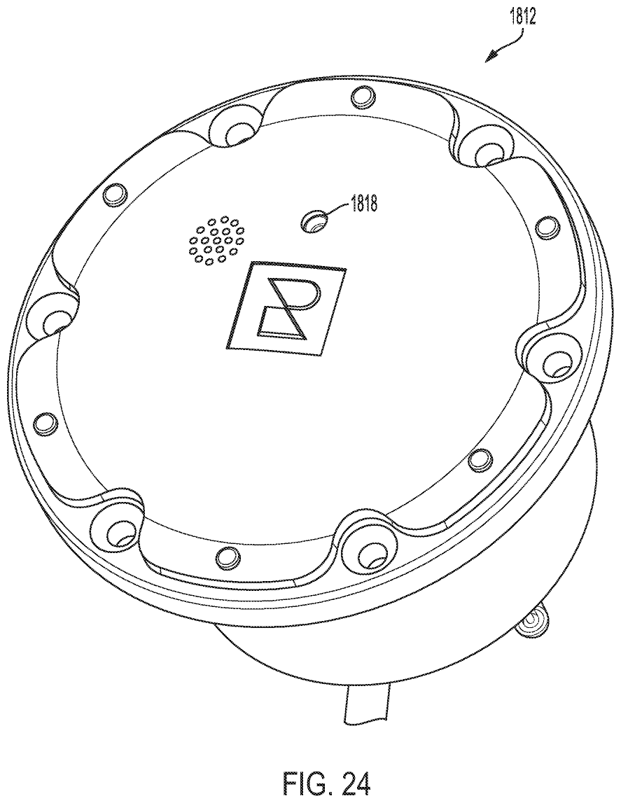

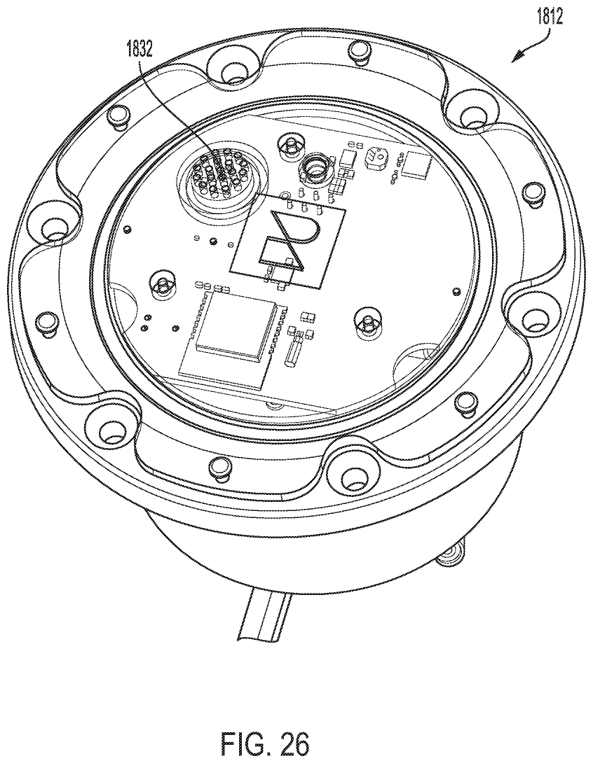

Various non-limiting embodiments of the present disclosure will now be described to provide an overall understanding of the principles of the structure, function, and use of systems, apparatuses, devices, and methods disclosed. One or more examples of these non-limiting embodiments are illustrated in the selected examples disclosed and described in detail with reference made to FIGS. 1-29 in the accompanying drawings. Those of ordinary skill in the art will understand that systems, apparatuses, devices, and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems, and can use other protocols, or operate at other layers in communication protocol stacks, then are described.

As described in more detail below, the present disclosure generally relates to liquid level detection, monitoring, and reporting. While the following examples are described in the context of bourbon production for the purposes of illustration, this disclosure is not so limited. Instead, the systems, apparatuses, devices, and methods described herein can be applicable to a variety of instances in which liquid is stored in a container, such as during wine production. Moreover, beyond consumable liquids, the systems, apparatuses, devices, and methods described herein are also applicable to the level detection, monitoring, and reporting of any liquid that is stored in a container, such as chemicals, oils, or industrial liquids. Thus, while many of the examples described herein relate to bourbon barrels, it is to be readily appreciated that the systems, apparatuses, devices, and methods can have applicability across a variety of different types of storage tanks, vessels, and the like.

FIG. 1 schematically depicts a storage container 100 in accordance with one non-limiting embodiment. The storage container 100 can be configured to store a liquid 102 over a period of time. As is to be appreciated, the length of the period of time can vary based on the type of liquid 102, but in some embodiments the length of time is months, years, or even decades. The storage container 100 can be formed of a side wall 108 that connects end walls 110. FIG. 1 shows the storage container 100 in a horizontal position, although other storage containers may be stored in a vertical position without departing from the scope of the present disclosure. The liquid 102 fills a portion of the interior volume of the storage container 100. The space between the top surface of liquid 102 and the walls of the storage container 100 is generally referred to headspace 106. As the liquid 102 evaporates over time, the vapor can fill the headspace 106, or even leak out of the storage container 100, which can cause the liquid level 104 to decrease over time. Additionally, the liquid 102 may leak out of cracks, gaps, seals, holes, or other types of openings or pathways in the storage container 100, which can also cause the liquid level 104 to decrease over time. Further, due to the porosity of the side wall 108 or the end walls 110, the liquid 102 may temporarily penetrate into the walls (i.e., during times of expansion). In the case of bourbon, for example, the repeated penetration of the liquid 102 into the walls 108, 110 over time is what helps the bourbon to achieve the desired flavor.

As schematically depicted in FIG. 1, the storage container 100 has a liquid monitoring system 112 that is configured to monitor the liquid level 104 over time. The liquid monitoring system 112 can have interior componentry 114 and exterior componentry 116. Portions of the interior componentry 114 can be configured to be in contact with the liquid 102. In this regard, the interior componentry 114 can include a submersible housing 122 that is configured to be liquid tight. The liquid monitoring system 112 can include a sensor array 118 having at least one sensor 120. In some embodiments, the sensor array 118 can be positioned inside the submersible housing 122, although this disclosure is not so limited. The at least one sensor 120 can be used to determine the liquid level 104 of the liquid 102 within the container 100. As described in more detail below, the liquid level 104 can be measured or determined using any of a variety of suitable liquid level determination techniques. Further, in some embodiments, the sensor array 118 can be used to collect other data related to the container 100, the liquid 102, and/or the headspace 106. For example, the sensor array 118 can include one or more sensors 120 for measuring temperature, vapor pressure, barometric pressure, among other characteristics.

In accordance with various embodiments, the liquid monitoring system 112 can include an external housing 124. The external housing 124 can house various componentry, such as communication componentry. For example, in some embodiments, the liquid monitoring system 112 can communicate data via a wireless network connection to a remote computing device. Such communication can be facilitated through an antenna 126 that can utilize any suitable networking protocol. A communication bus 130 can generally connect the sensor array 118 to componentry in the external housing 124. The communication bus 130 can be a wired connection or utilize wireless communication protocols, such as near field communication protocols. Further, in some embodiments, the liquid monitoring system 112 can include a local notification device 128. The local notification device 128 can be any suitable type of auditory or visual device, such as a speaker, a light, a graphical display, and so forth. Such local notification device 128 can aid in rapid identification of the container 100.

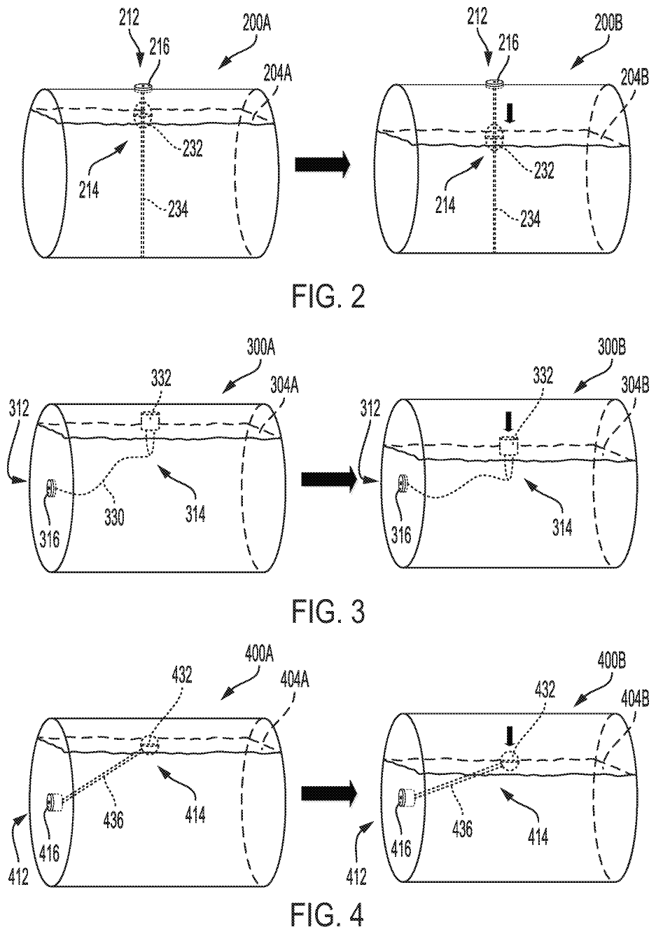

In accordance with liquid monitoring systems of the the present disclosure, a variety of different techniques can be used to determine the level of a liquid stored in a container and to track the level over time. FIGS. 2-4 schematically depict non-limiting examples of various liquid monitoring systems.

Referring first to FIG. 2, a container 200 has a liquid level 204A at a first point in time (shown in container 200A) and a liquid level 204B at a second point in time (shown in container 200B). A liquid monitoring system 212 is coupled to the container 200 and has exterior componentry 216 and interior componentry 214. In this illustrated embodiment, the interior componentry 214 includes a track 234 that extends into the liquid. The interior componentry 214 also includes a float 232 that is configured to ride on the track 234. The position of the float 232 on the track 234 can be used to determine a level of liquid in the container, with either the float 232 or the track 234 generating a corresponding signal. As shown, as the liquid level drops from a first level 204A to a second level 204B, the float 232 travels down the track 234.

Referring next to FIG. 3, a container 300 has a liquid level 304A at a first point in time (shown in container 300A) and a liquid level 304B at a second point in time (shown in container 300B). A liquid monitoring system 312 is coupled to the container 300 and has exterior componentry 316 and interior componentry 314. In this illustrated embodiment, the interior componentry 314 includes a float 332 that is connected to the exterior componentry 316 via a communication bus 330. The position of the float 332 can be used to determine a level of liquid in the container, with the float 332 generating a corresponding signal.

Referring next to FIG. 4, a container 400 has a liquid level 404A at a first point in time (shown in container 400A) and a liquid level 404B at a second point in time (shown in container 400B). A liquid monitoring system 412 is coupled to the container 400 and has exterior componentry 416 and interior componentry 414. In this illustrated embodiment, the interior componentry 414 includes a float 432 that is connected to an arm 436. The position of the arm 436 can be used to determine a level of liquid in the container, with the arm 436 pivoting downward as the float 432 travels downward with the liquid level. Additional details regarding example liquid monitoring systems having pivoting arms are provided below.

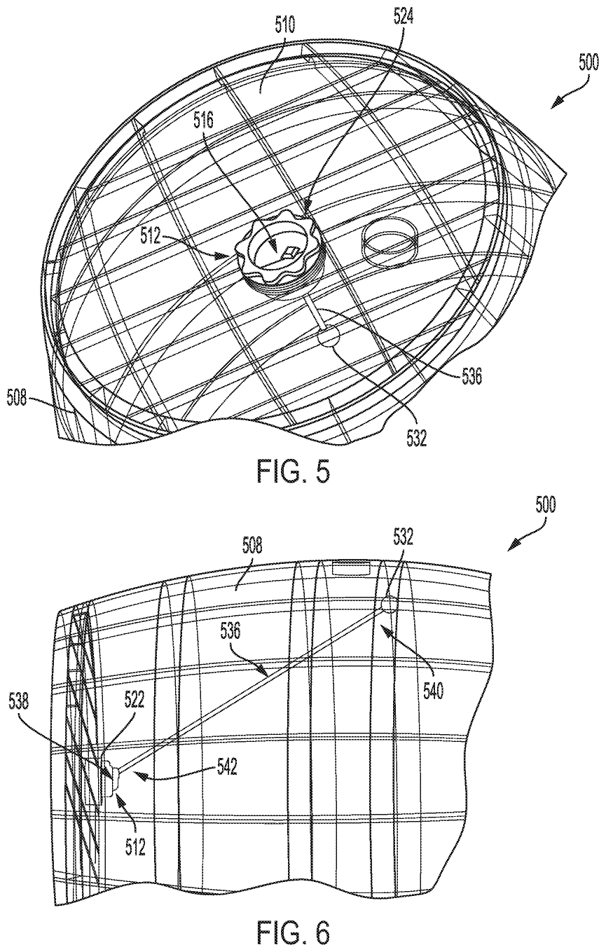

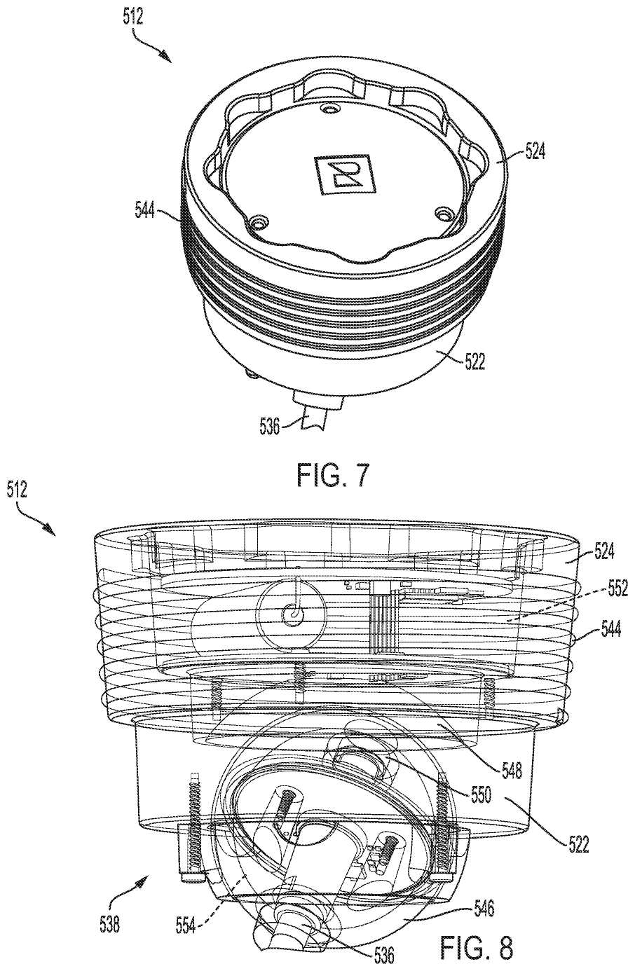

FIGS. 5-8 depict an example embodiment of a liquid monitoring system 512 that can be installed into an end wall 510 of a wooden storage container 500. As shown in FIGS. 5-6, the liquid monitoring system 512 can penetrate the end wall 510 such that exterior componentry 516 is accessible from outside the container 500. The liquid monitoring system 512 can include an arm 536 that extends into the container 500. A float 532 can be positioned at the distal portion of the arm 536, with the opposing, proximal end 542 of the arm 536 coupled to a submersible housing 522. FIG. 7 is a perspective view of a portion of the liquid monitoring system 512. The liquid monitoring system 512 includes an external housing 524 and the submersible housing 522. The external housing 524 can have threads 544 that allow the liquid monitoring system 512 to be threaded through the end wall 510. In some embodiments, the end wall 510 is pre-drilled with a hole saw prior to the threading of the liquid monitoring system 512 through the end wall 510. In some embodiments, a bore in the end wall 510 can be threaded to match the threads 544 of the external housing 524. In some embodiments, other means are used to attach the liquid monitoring system to the container.

FIG. 8 depicts example internal componentry of the liquid monitoring system 512. The external housing 524 can define a first cavity 552 in which various circuitry is positioned. As shown, the arm 536 can be coupled to a pivot ball 546 that is received into the submersible housing 522 to form a pivot assembly 538. In some embodiments, the pivot ball 546 houses a magnet 550. The magnet 550 can be coupled, for example, to the arm 536. Further, in some embodiments, the pivot ball 546 can define a second cavity 554. One or more sensors may be positioned within the second cavity 554. As the pivot ball 546 moves within the pivot assembly 538, its relative position can be tracked based on the position of the magnet 550 relative to a tracking surface 548, as described in more detail below.

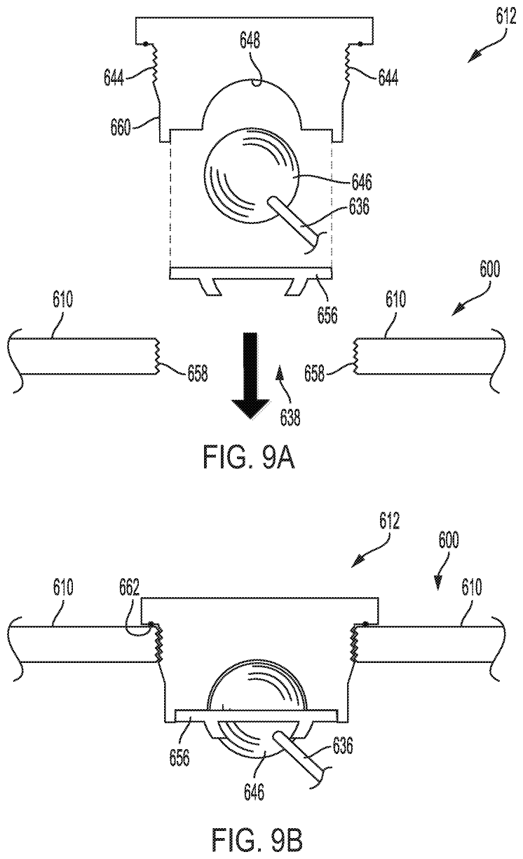

FIG. 9A depicts an exploded view of an example liquid monitoring system 612 prior to installation into a wall 610 of a container 600. FIG. 9B depicts the liquid monitoring system 612 subsequent to installation into the wall 610 of the container 600. As shown in FIG. 9A, the liquid monitoring system 612 can include a housing 660 having external threads 644. The housing 660 can define a tracking surface 648 which is positioned proximate to a pivot ball 646. The pivot ball 646 can be coupled to an arm 636, such that pivoting movement of the arm 636 causes rotational movement of the pivot ball 646 relative to the tracking surface 648. A retaining collar 656 can be coupled to the housing 660 that retains the pivot ball 646 but allows for freedom of rotation. The liquid monitoring system 612 can be placed through a port 638 defined by the wall 610 of the container 600. The port 638 can have threads 658. As shown in FIG. 9B, the liquid monitoring system 612 can be installed into the wall 610 of the container 600 such that a liquid tight seal is formed therebetween. In some embodiments a seal 662 is utilized to aid in creating the seal. In some embodiments, the threaded engagement itself creates a sufficient seal.

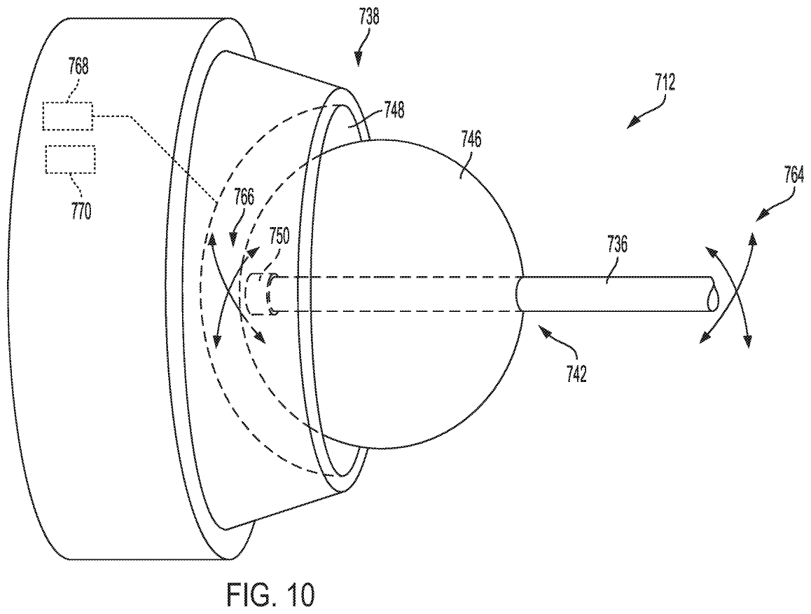

FIG. 10 schematically depicts a pivot assembly 738 of an example liquid monitoring system 712 in accordance with one non-limiting embodiment. The liquid monitoring system 712 has an arm 736 that can pivot multidirectionally, as indicated by arrows 764. A pivot ball 746 can be positioned at a proximal end 742 of the arm 736. The arm 736 can extend into the pivot ball 746, as shown, although this disclosure is not so limited. Instead, for example, the arm 736 can be coupled to an outer surface of the pivot ball 746. The pivot ball 746 can house a magnet 750 that moves in response to the pivoting of the arm 736. As such, the magnet 750 can generally translate along a tracking surface 748 as illustrated by arrows 766. The position of the magnet 750 can be tracked by a position sensor 768. Thus, as the arm 736 pivots over time (i.e., due to a decrease in liquid level), the pivot ball 746 will rotate and the magnet 750 will move relative to the tracking surface 748. In some embodiments, the liquid monitoring system 712 includes a gravity vector sensor 770 that is used to calibrate the movement of the pivot ball 746. Such calibration can be useful, for example, if the associated container is moved or its orientation is changed.

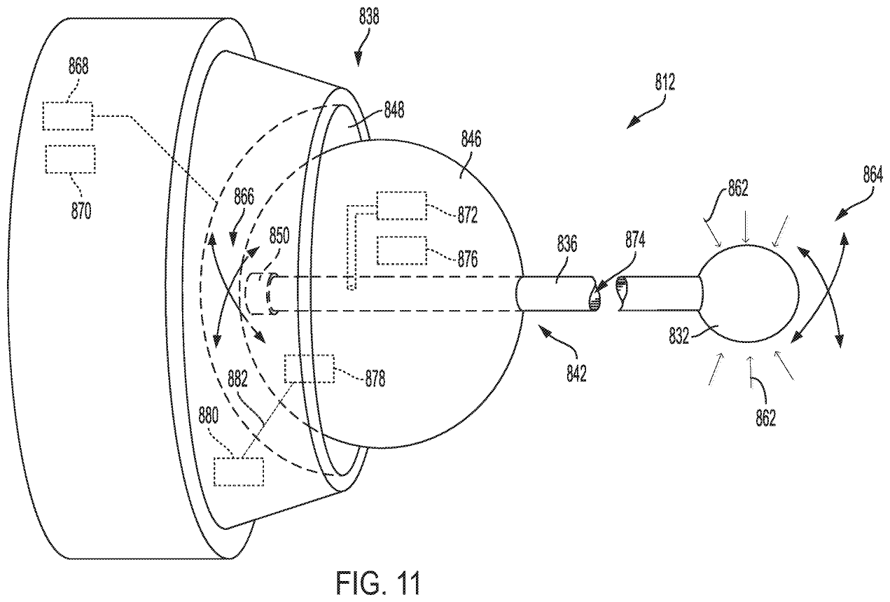

FIG. 11 schematically depicts a pivot assembly 838 of an example liquid monitoring system 812 in accordance with one non-limiting embodiment. Similar to FIG. 7, the liquid monitoring system 812 has an arm 836 that can pivot multidirectionally, as indicated by arrows 864. A pivot ball 846 can be positioned at a proximal end 842 of the arm 836. The pivot ball 846 can house a magnet 850 that moves in response to the pivoting of the arm 836. As such, the magnet 850 can generally translate along a tracking surface 848 as illustrated by arrows 866. The position of the magnet 850 can be tracked by a position sensor 868. The liquid monitoring system 812 can include a gravity vector sensor 870 that is used to calibrate the movement of the pivot ball 846. The liquid monitoring system 812 can also include a float 832 positioned at the distal end of the arm 836. The arm 836 can define an internal pressure channel 874 that is in communication with an internal chamber of the float 832. In some embodiments, the arm 836 is formed from ¼″ 304 stainless hollow tubing. The float 832 can be deformable such that it expands and contracts based on pressure. As such, when the pressure increases (indicated by arrows 862), the float 832 will contract, thereby increasing the pressure in the pressure channel 874. A pressure sensor 872 can be positioned within the pivot ball 846 and can detect the change in the vapor pressure. The pivot ball 846 can house additional sensors 876, such as a temperature sensor for example. The pivot ball 846 can be sealed to protect the internal sensors 872, 876 from exposure to liquid. As such, the pivot ball 846 can house a first NFC module 878 that is configured to provide data to a second NFC module 880 via a wireless communication link 882.

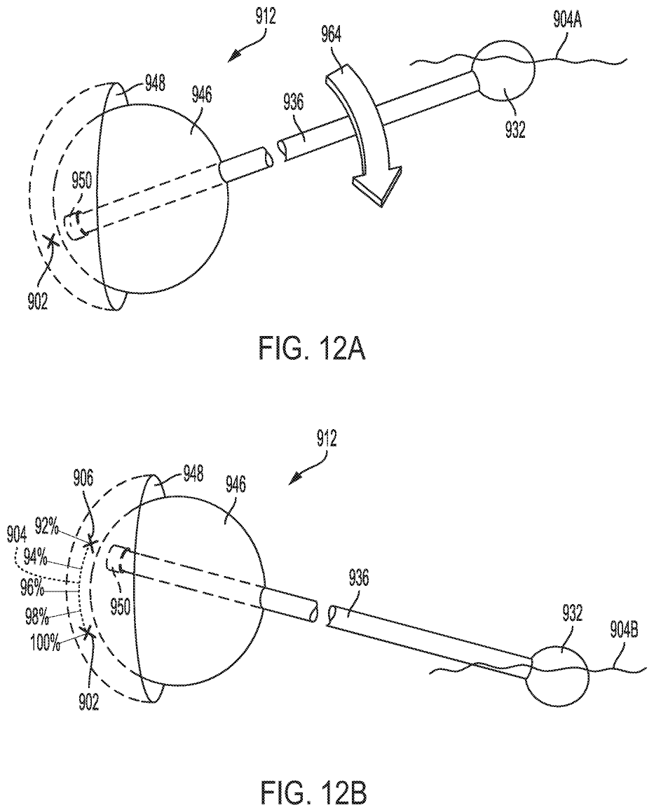

FIGS. 12A-12B schematically depict the tracking of liquid volume in a container in accordance with various non-limiting embodiments. Similar to previously described embodiments, a liquid monitoring system 912 can include an arm 936 with a float 932 positioned at one end and a pivot ball 946 at the other. As an initial position, due to the liquid level 904A, the float 932 will cause a magnet 950 of the pivot ball 946 to be at a starting location 902 on a tracking surface 948. As shown in FIG. 12B, this starting location 902 can be calibrated as the 100% level, with the actual volume determined based on the size of the container. As the liquid level drops over time, the arm 936 will pivot in the direction indicated by arrow 964 in FIG. 12A. As this movement occurs, the magnet 950 will track a path 904 along the tracking surface 948. The liquid monitoring system 912 can be calibrated such that points along that path 904 correspond to certain percentages of liquid loss. FIG. 12B shows the magnet 950 location based on the location of the float 932 at the current liquid level 904B. The ending location 906 on the tracking surface 948 is determined. Based on the known physical parameters of the container, the ending location 906 can correspond to, for example, an 8% decrease in overall volume.

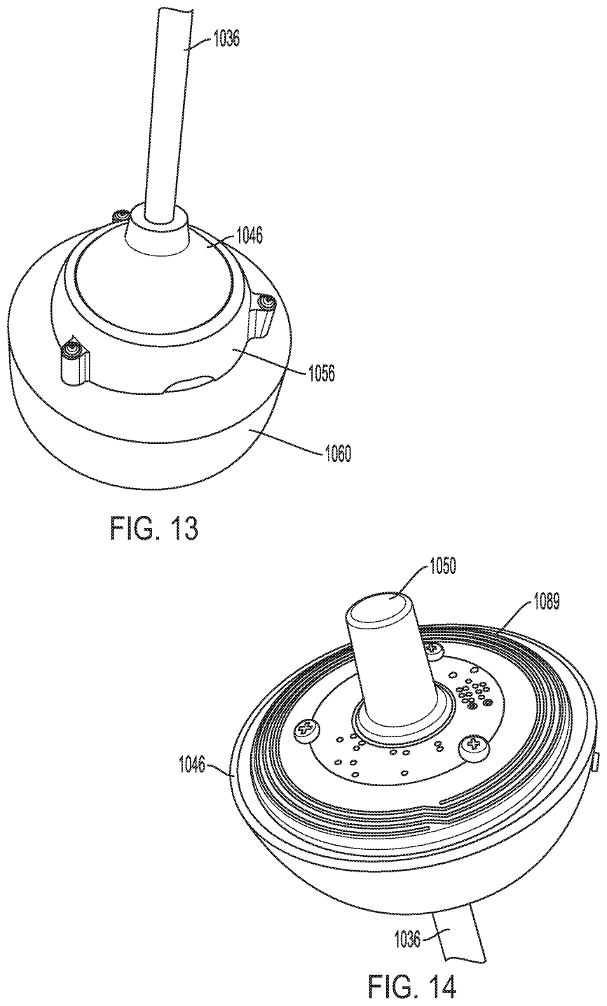

FIGS. 13-14 show example components of a liquid monitoring system in accordance with one non-limiting embodiment. Referring first to FIG. 13, a pivot ball 1046 is shown coupled to an arm 1036. The pivot ball 1046 is retained to a housing 1060 by a retaining collar 1056. FIG. 14 shows the interior of the pivot ball 1046. As shown, a magnet 1050 can be positioned within the pivot ball 1046, along with various pivot ball circuitry 1084.

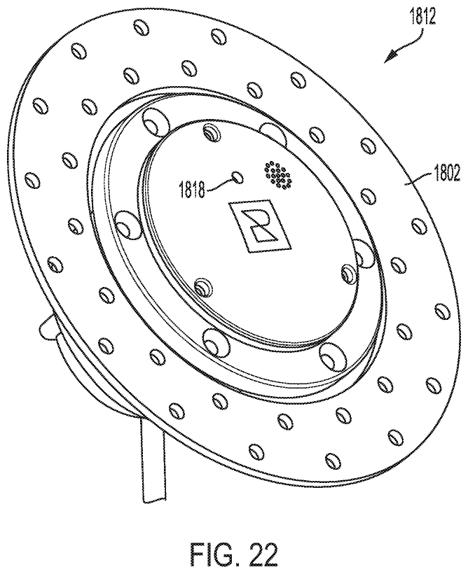

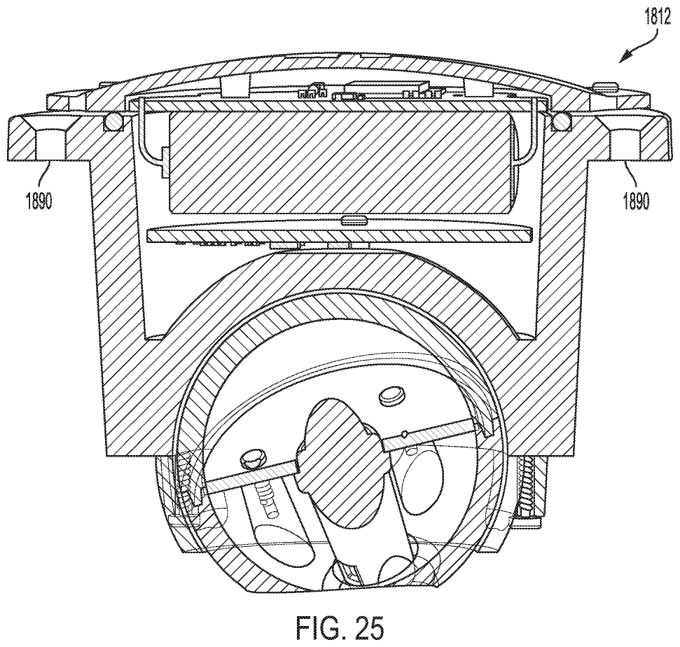

Referring now to FIGS. 22-27, a liquid monitoring system 1812 in accordance with another example embodiment is depicted. FIG. 25 depicts a cross-sectional view of the liquid monitoring system 1812. In the embodiment, the liquid monitoring system 1812 includes a visual indicator 1818 (FIG. 22) that can be selectively illuminated in response to an illumination command. Such illumination command can be received from a remove computing system, such as to assist an operator in locating a particular barrel. The illumination command can also be received locally in response to the detection of certain events, such as a leakage events, pressure events, and so forth. The liquid monitoring system 1812 also includes a sensor 1832 for measuring ambient conditions, such as temperature, humidity, pressure, etc.

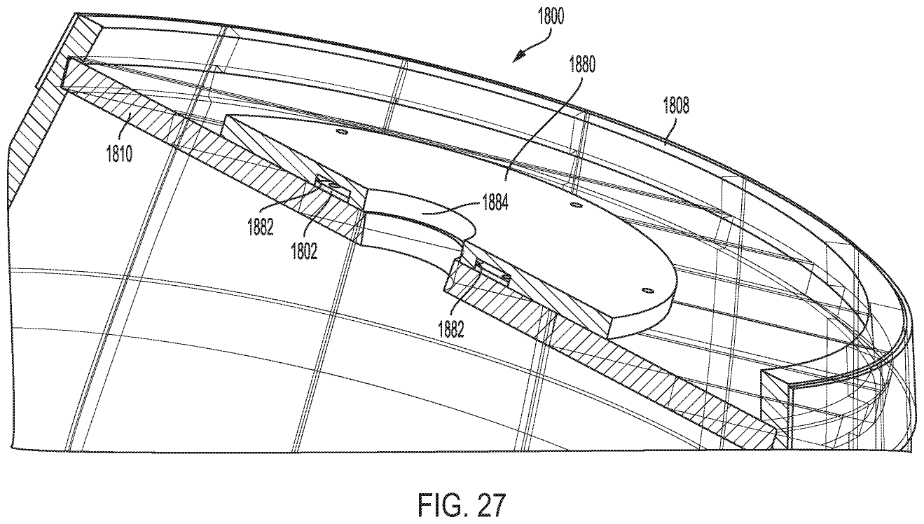

As shown in FIGS. 22 and 27, a brace 1802 can be utilized in various embodiments. The brace 1802 can be fastened to an end wall 1810 of a container 1800, or other location on a container to which a liquid monitoring system is mounted. In some embodiments, food grade stainless screws can be used to fasten the brace 1802 to the end wall 1810. The brace 1802 may aid in maintaining the structural integrity of the end wall 1810, as in some embodiments, the end wall 1810 is formed from a plurality of staves that are coupled via tongue and groove connections. Further, over time the end wall 1810 may bow, which could potentially lead to leaks at the installation site of the liquid monitoring system 1812. The brace 1802 can therefore aid in maintaining portions of the end wall 1810 in a planar arrangement and reduce or minimize leakage.

With regard to installing the liquid monitoring system 1812 to the container 1800, the brace 1802 can first be fastened to the end wall 1810 using screws, or other connection technique. Next, a cutting guide 1880 can temporarily be placed on top of the brace 1802, as shown in FIG. 27. The cutting guide 1880 may define a groove 1882 that is sized to receive the brace 1802 and to provide proper alignment. The cutting guide 1880 can also define a central opening 1884 that serves as a guide or track for a tool to follow when an operator cuts a port into the end wall 1810. In some embodiments, the tool is a router, a hole saw, a zip saw, or a jig saw, for example. One the port is cut into the end wall 1810, the cutting guide 1802 can be removed and the liquid monitoring system 1812 can be mounted into the port. As shown in FIG. 25, the liquid monitoring system 1812 can define mounting holes 1890 through which screws, or other fastening members, can be placed and driven into the end wall 1810.

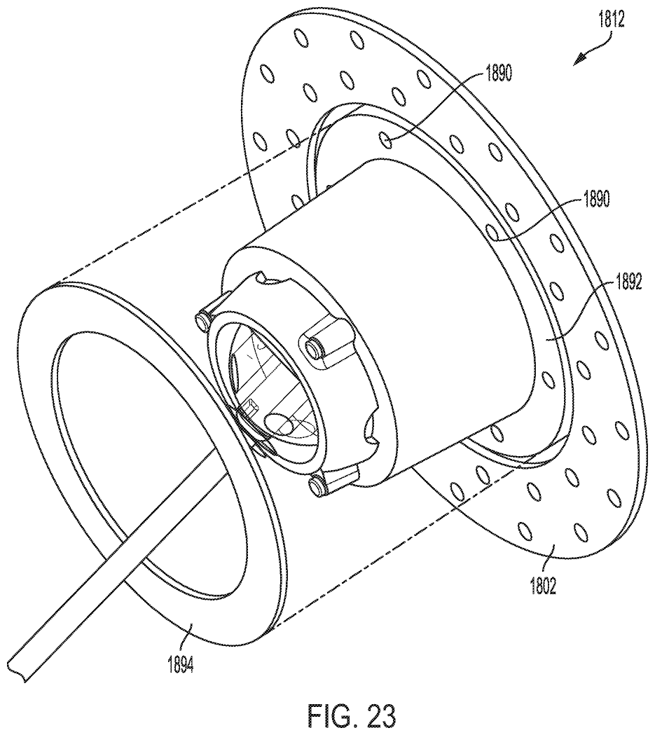

As shown in FIG. 23, in some embodiments a washer 1894 can be placed between a flange 1892 and the end wall 1810 (FIG. 27). The washer 1894 can be formed, for example, from a thin sheet of cedar, or other suitable material. In embodiments utilizing a cedar washer 1894, mounting screws can be fed through mounting holes 1890, through the cedar washer 1894, and ultimately into the end wall 1810.

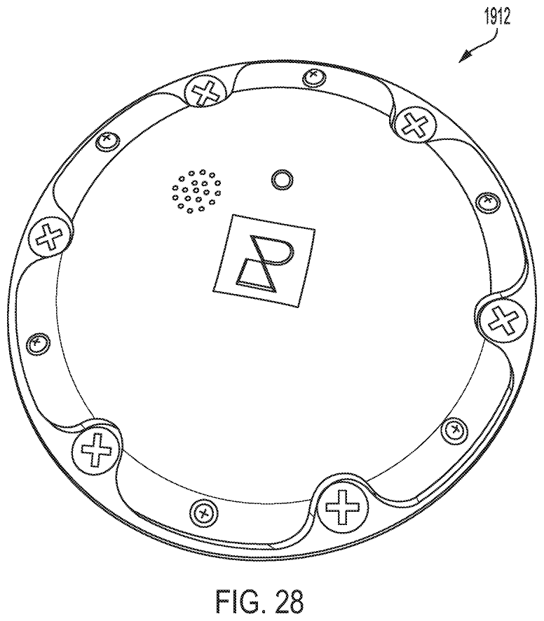

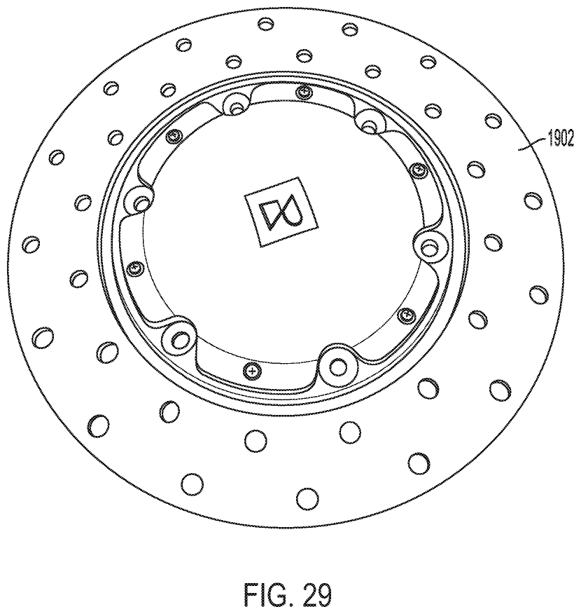

FIGS. 28-29 show an example liquid monitoring system 1912 in accordance with one non-limiting embodiment. FIG. 29 shows an example brace 1902. As is to be appreciated, the size and shape of the brace 1902 may vary without departing from the scope of the present disclosure.

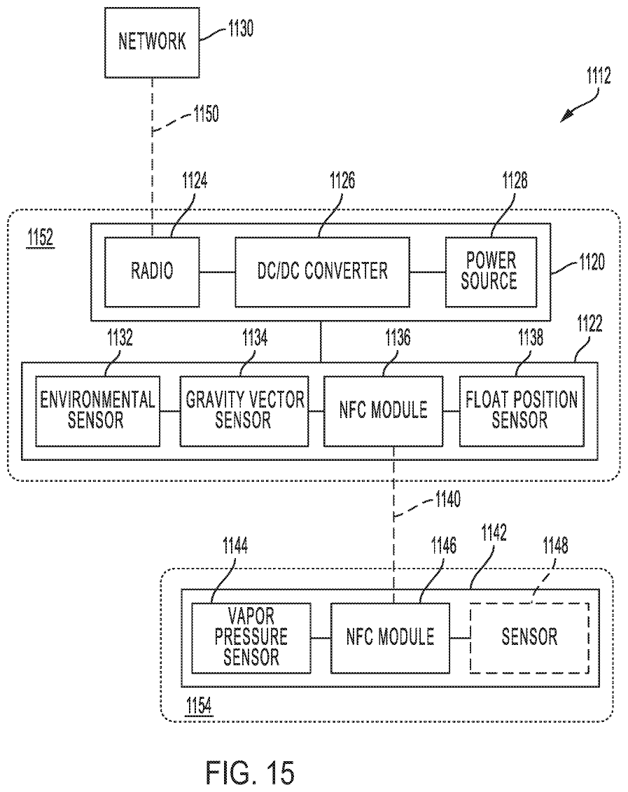

Referring now to FIG. 15, block diagram of an example liquid monitoring system 1112 in accordance with one non-limiting embodiment is shown. The liquid monitoring system 1112 can have circuitry positioned within a first cavity 1152 and other circuitry positioned in a second cavity 1154. The second cavity 1154 may be defined, for example, by a pivot ball. The circuitry in the first cavity 1152 can be in communication with the circuit in the second cavity 1154 via a wireless communications link 1140.

The liquid monitoring system 1112 can having a first board 1120 that includes various components, such as a radio 1124, a DC/DC converter 1126, and a power source 1128. The radio 1124 can be any suitable radio or interface, such as a Fanstel nRF528xx Module (BLE5 Radio). The DC/DC converter 1126 can be, for example, an LTC3335 regulator and coulomb counter. The power source 1128 can be, for example, a Tadiran 2.4Ah AA LiSOCl₂ primary cell. A second board 1122 can have other components, such as an environmental sensor 1132, a gravity vector sensor 1134, and a float position sensor 1138. The environmental sensor 1132 can be, for example, a Bosch BME280 Pressure/Temperature/Humidity sensor. The gravity vector sensor 1134 can be, for example, a Bosch BMA253 3-axis Accelerometer. The float position sensor 1138 can be, for example, a Melexis MLX 3D magnetometer. The second board 1122 can have an NFC module 1136, such as a NXP PN5120A Reader/Writer/Tag, to enable the NFC communication with the pivot ball board 1142. The pivot ball board 1142 can have a variety of components, such as a vapor pressure sensor 1144 and an NFC module 1146. The vapor pressure sensor 1144 can be, for example, an M Bosch BME280 Pressure/Temperature/Humidity sensor. The NFC module 1146 can be, for example, a NXP NHS3100 Cortex M0+/Dynamic NFC Tag. The pivot ball board 1142 can include other sensors 1148, such as a precision temperature sensor.

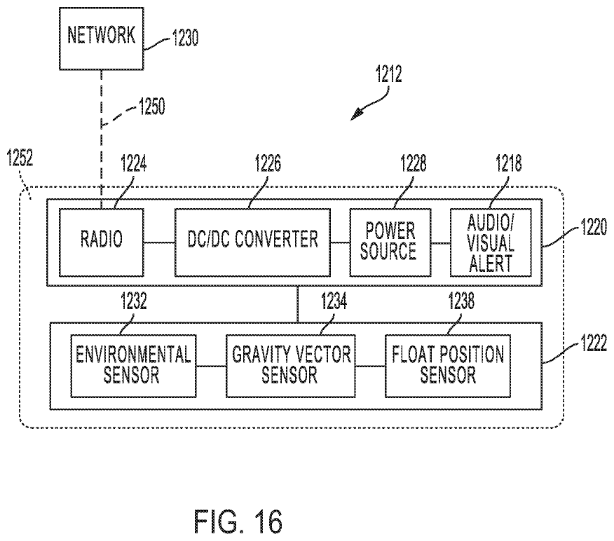

FIG. 16 shows a block diagram of an example liquid monitoring system 1212 in accordance with one non-limiting embodiment. In this example embodiment, the liquid monitoring system 1212 does not have circuitry positioned within a pivot ball. The liquid monitoring system 1212 can have a first board 1220 that includes various components, such as a radio 1224, a DC/DC converter 1226, and a power source 1128. The first board 1220 can also have an alert 1218, such as a visual or audio alert. The radio 1224 can by any suitable radio or interface, such as a Fanstel nRF528xx Module (BLE5 Radio). The DC/DC converter 1226 can be, for example, an LTC3335 regulator and coulomb counter. The power source 1228 can be, for example, a Tadiran 2.4Ah AA LiSOCl₂ primary cell. A second board 1222 can have other components, such as an environmental sensor 1232, a gravity vector sensor 1234, and a float position sensor 1238. The environmental sensor 1232 can be, for example, a Bosch BME280 Pressure/Temperature/Humidity sensor. The gravity vector sensor 1234 can be, for example, a Bosch BMA253 3-axis Accelerometer. The float position sensor 1238 can be, for example, a Melexis MLX 3D magnetometer.

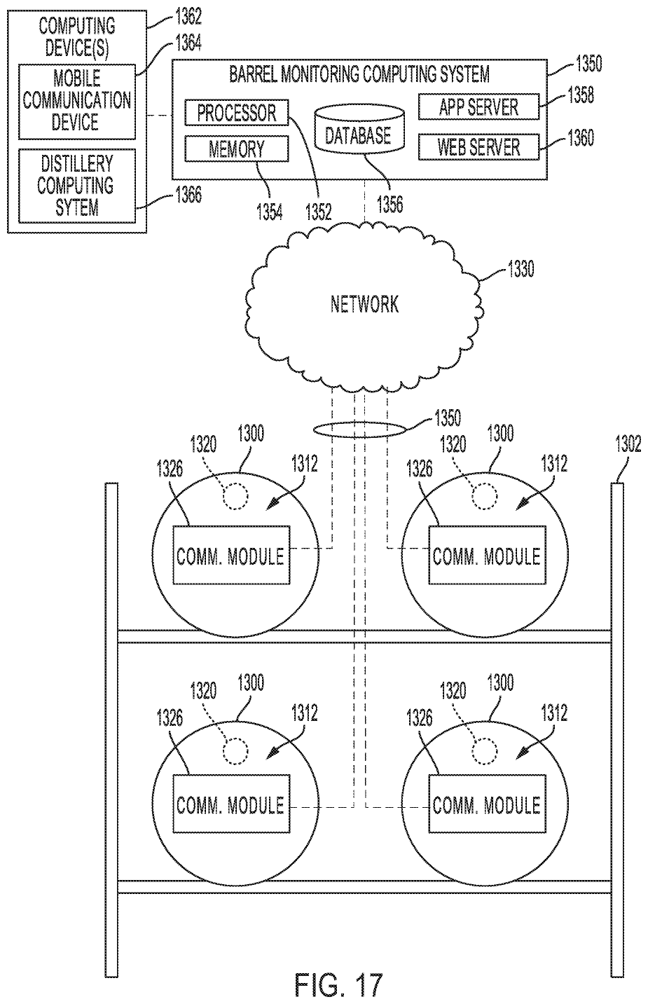

FIG. 17 depicts a plurality of example storage containers 1300 stored on a rack 1302. Each container 1300 can have a liquid monitoring system 1312 with a sensor 1320 for tracking the volume of liquid within the container. Communication modules 1326 can be used to supply relevant data to a barrel monitoring computing system 1350 via a network 1330. In some embodiments, each of the communication modules 1326 is in communication with a mesh network via communication links 1350. The barrel monitoring computing system 1350 provide information to various computing devices 1362, such as a mobile communication device 1364 or a distillery computing system 1366. Such information can relate to, for example, volume levels of various containers 1300 and environmental data associated with various containers 1300.

The barrel monitoring computing system 1350 can include one or more processors 1352 configured to execute code stored in memory 1354. Data collected from various barrels can be stored in various types of data stores, schematically shown as database 1356. The barrel monitoring computing system 1350 can further include one or more computer servers, which can include one or more web servers, one or more application servers, and/or other types of servers. For convenience, only one web server 1360 and one application server 1358 are depicted in FIG. 17, although one having ordinary skill in the art would appreciate that the disclosure is not so limited. The servers 1358, 1360 can cause content to be sent to the computing devices 1362, or other computing devices, via a network in any of a number of formats. The servers 1358, 1360 can be comprised of processors (e.g. CPUs), memory units (e.g. RAM, ROM), non-volatile storage systems (e.g. hard disk drive systems), and other elements. The servers 1358, 1360 may utilize one or more operating systems including, but not limited to, Solaris, Linux, Windows Server, or other server operating systems.

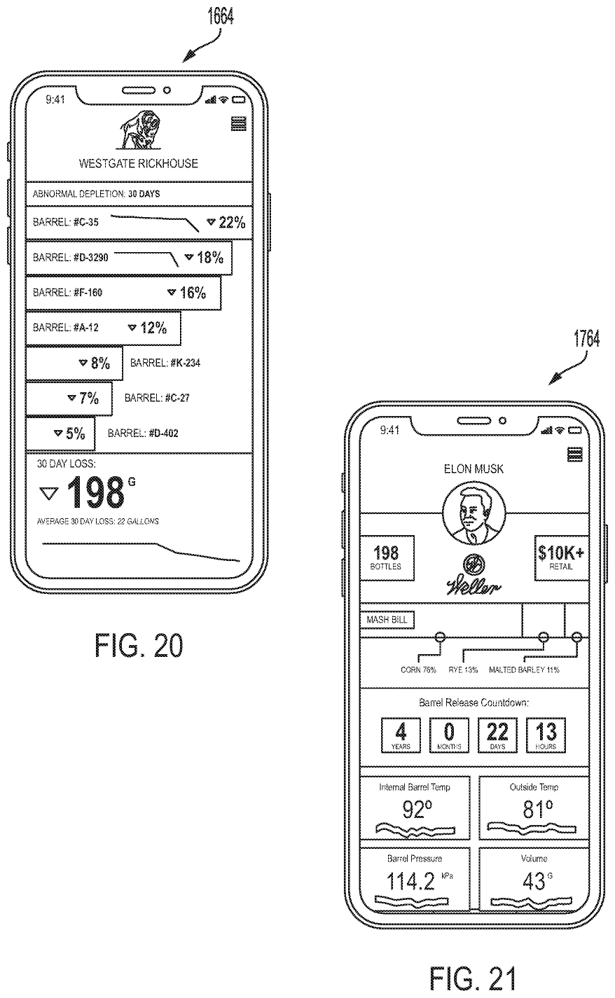

In some embodiments, the web server 1358 can provide a graphical web user interface through which various users can interact with the barrel monitoring computing system 1350, examples of which are described in more detail below with regard to FIGS. 20-21. The graphical web user interface can also be referred to as a graphical user interface, client portal, client interface, graphical client interface, and so forth. The web server 1360 can accept requests, such as HTTP requests, from clients and serve the clients responses, such as HTTP responses, along with optional data content, such as web pages (e.g. HTML documents) and linked objects (such as images, video, documents, data, and so forth). The application server 1358 can provide a user interface for users who do not communicate with the barrel monitoring computing system 1350 using a web browser. Such users can have special software installed on their computing device to allow the user to communicate with the application server 1358 via a network.

The barrel monitoring computing system 1350 can be in communication with the containers 1300 via the network 1330, using a suitable communications interface. The network 1330 can be an electronic communications network and can include, but is not limited to, the Internet, LANs, WANs, GPRS networks, other networks, or combinations thereof. The network 1330 can include wired, wireless, fiber optic, other connections, or combinations thereof. In general, the network 1330 can be any combination of connections and protocols that will support communications between the barrel monitoring computing system 1350 and the liquid monitoring systems 1312. In some embodiments, the liquid monitoring systems 1312 provide raw data collected by various sensors to the barrel monitoring computing system 1350, and the barrel monitoring computing system 1350 performs analysis on the data to access volume change, and so forth. Additionally, in some embodiments, the liquid monitoring systems 1312 include an NFC front-end to allow for local reading of the sensors at the location of the container 1300.

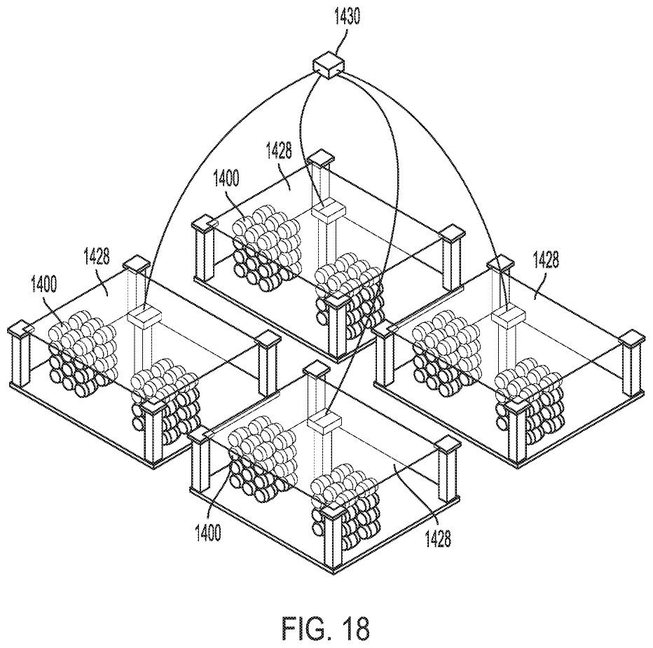

FIG. 18 depicts an operational environment in accordance with one non-limiting embodiment. A collection of barrels 1400 are shown stored in four rickhouses. Each barrel 1400 is in communication with an associated local network 1428. The local networks 1428 can access a remote barrel monitoring computing system via a gateway 1430.

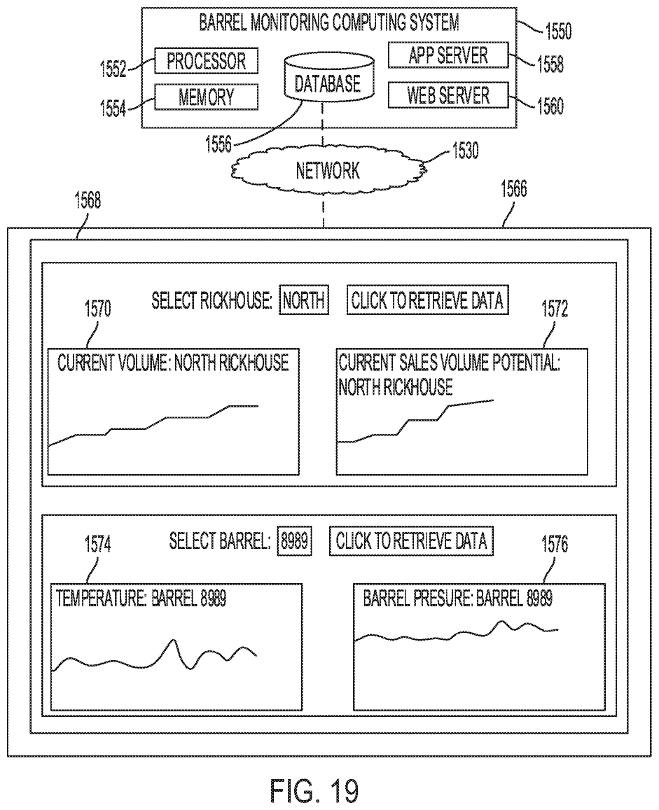

FIG. 19 schematically depicts a simplified example user interface 1568 that can be generated by a barrel monitoring computing system 1550. Similar to FIG. 17, barrel monitoring computing system 1550 can include, for example, a processor 1552, a memory 1554, a database 1556, and servers 1558, 1560. The barrel monitoring computing system 1550 can present the user interface 1568 via communications through a network 1530. As shown, using the data collected from the various barrels stored in a rickhouse, various trends or other information can be presented. In the illustrated embodiment, the user interface 1568 shows current volume 1570 and associate sales information 1572 for that rickhouse. As is to be appreciated, based on the real-time volume information, various operational adjustments can be made. Additionally, instead of viewing the data on a macro level, individual barrel data can be displayed. As shown, a particular barrel is selected, and a barrel temperature plot 1574 and a barrel pressure plot 1576 are provided via the interface.

FIGS. 20-21 depict example interfaces that may be presented on a mobile communications device. FIG. 20 depicts an interface 1664 providing information on inventory of a particular rickhouse. FIG. 21 depicts an interface 1764 providing information on a particular barrel of bourbon based on data collected from a liquid monitoring system associated with the barrel.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent articles by those of ordinary skill in the art. Rather it is hereby intended the scope be defined by the claims appended hereto.

What is claimed is:

1. A liquid monitoring system for mounting through a sidewall of a storage container, the liquid monitoring system comprising:
a housing defining a first cavity;
a pivot ball assembly that is pivotably coupled to the housing, the pivot ball assembly comprising a magnet;
an arm having a proximal end and a distal end, wherein the proximal end of the arm is coupled to the pivot ball assembly;
a float coupled to the distal end of the arm; and
at least one sensor, a radio, and a power source disposed at least partially within the first cavity.

2. The liquid monitoring system of claim 1, wherein the magnet is coupled to the proximal end of the arm.

3. The liquid monitoring system of claim 2, wherein the least one sensor facilitates tracking of movement of the magnet relative to the housing.

4. The liquid monitoring system of claim 1, wherein the pivot ball assembly defines a second cavity, wherein the magnet is disposed at least partially inside the second cavity and wherein the first cavity and the second cavity are not in fluid communication.

5. The liquid monitoring system of claim 4, further comprising a temperature sensor disposed at least partially within the second cavity.

6. The liquid monitoring system of claim 4, further comprising a pressure sensor disposed at least partially within the second cavity.

7. The liquid monitoring system of claim 6, wherein the arm defines an internal pressure channel extending between the proximal end and the distal end.

8. The liquid monitoring system of claim 7, wherein the pressure sensor is in fluid communication with the float via the internal pressure channel.

9. The liquid monitoring system of claim 4, wherein a first near field communication module is disposed at least partially within the first cavity and a second near field communication module is disposed at least partially within the second cavity.

10. A system, comprising:
a plurality of liquid monitoring systems, wherein each liquid monitoring system is associated with a respective liquid storage container in a storage facility and each liquid monitoring system comprises at least one sensor and a wireless communication module; and
a storage container monitoring computing system comprising computer-readable medium having computer-executable instructions stored thereon, the storage container monitoring computing system in networked communication with each liquid monitoring system of the plurality of liquid monitoring systems over a communications network, the computer-executable instructions configured to instruct one or more computer processors to perform the following operation:
receive communications over the communications network from each of the plurality of liquid monitoring systems, wherein the communications comprises environmental data associated with the liquid storage container that is associated with each liquid monitoring system.

11. The system of claim 10, wherein the computer-executable instructions are further configured to instruct one or more computer processors to perform the following operation:
receive communications over the communications network from each of the plurality of liquid monitoring systems, wherein the communications indicate a volume level for the liquid storage container that is associated with each liquid monitoring system.

12. The system of claim 10, wherein the storage facility comprises a rickhouse and each storage container comprises a barrel of distilled spirits.

13. The system of claim 10, wherein each of the plurality of plurality of liquid monitoring systems comprises:
a housing defining a first cavity;
a pivot ball assembly that is pivotably coupled to the housing, the pivot ball assembly comprising a magnet;
an arm having a proximal end and a distal end, wherein the proximal end of the arm is coupled to the pivot ball assembly; and
a float coupled to the distal end of the arm.

14. The system of claim 13, wherein the magnet is coupled to the proximal end of the arm.

15. The system of claim 13, wherein the pivot ball assembly defines a second cavity, wherein the first cavity and the second cavity are not in fluid communication.

16. The system of claim 13, wherein each liquid monitoring system of the plurality of plurality of liquid monitoring systems comprises a temperature sensor.

17. The system of claim 16, wherein the computer-executable instructions are further configured to instruct one or more computer processors to perform the following operations:
receive communications over the communications network from each of the plurality of liquid monitoring systems, wherein the communications indicate a temperature that is associated with each respective liquid monitoring system.

18. A monitoring system, comprising:
a liquid storage container having a sidewall that defines an interior volume;
a liquid monitoring system mounted through the sidewall of the liquid storage container, wherein the liquid monitoring system comprises;
a housing;
a pivot ball assembly that is pivotably coupled to the housing, the pivot ball assembly comprising a magnet;
an arm having a proximal end and a distal end, wherein the proximal end of the arm is coupled to the pivot ball assembly;
a float coupled to the distal end of the arm; and
at least one sensor, a radio, and a power source; and
wherein a first portion of the liquid monitoring system extends into the interior volume of the liquid storage container; and
wherein a second portion of the liquid monitoring system is external to the interior volume of the liquid storage container.

19. The monitoring system of claim 18, wherein the liquid monitoring system is in networked communication with a remote storage container monitoring computing system.

20. The monitoring system of claim 18, wherein the least one sensor facilitates tracking of movement of the magnet relative to the housing.
